(19) United States
(12) Patent Application Publication
(10) Pub. No.: US 2018/0186681 A1
(43) Pub. Date: Jul. 5, 2018

(54) DEVICE FOR CONVEYING SHEETS OF GLASS

(71) Applicant: SAINT-GOBAIN GLASS FRANCE, Courbevoie (FR)

(72) Inventors: David DECHIROT, Faches-Tumesnil (FR); Jérôme GOBIN, Saint Leger aux Bois (FR); David BURGAUD, Candor (FR)

(21) Appl. No.: 15/738,930

(22) PCT Filed: Jun. 23, 2016
(86) PCT No.: PCT/FR2016/051549

§ 371 Date: Dec. 21, 2017

(30) Foreign Application Priority Data
Jun. 25, 2015 (FR) 1555849

(51) Int. Cl. C03B 35/16; C03B 23/03

(52) U.S. Cl. CPC C03B 35/16; C03B 2225/02; C03B 23/03

(57) ABSTRACT

A conveying device for conveying sheets of glass advancing one behind the other includes a conveyor for conveying the sheets of glass in a longitudinal direction and a detection device for detecting the orientation of a sheet of glass, the detection device including two stops each to come into contact with the edge face of the sheet of glass, the detection device delivering an electrical signal relating to each contact with each stop, the electrical signals being coupled to an acquisition system making it possible to establish the length of time between contacts between the sheet of glass and each stop.

The invention relates to the field of the conveying of sheets of glass and of the detection of the position and orientation of the sheets of glass conveyed, in particular in the context of an industrial bending process.

During an industrial process for processing sheets of glass conveyed horizontally one after the other, it may be beneficial to determine the moment at which a sheet of glass arrives at a precise point and its orientation when viewed from above. This detection can be put to good use to trigger a mechanism that acts on the sheet and for correcting the orientation of the sheets, in particular at the start of conveying. In particular, in the context of a method for the thermal bending of sheets of glass one after another, it is necessary for each sheet of glass to be positioned exactly facing the bending tool and at the correct orientation.

US2003154745 teaches a method for bending a sheet of glass comprising heating the sheet of glass up to a softening temperature, transporting the sheet of glass in a substantially horizontal path as far as a bending station which bends it between two forms, shaping the sheet of glass by pressing between the two forms, cooling the sheet of glass in a suitable station, these means comprising shaped rollers that receive the sheet of glass after bending and said rollers being oriented parallel to the direction defined on the sheet of glass by the direction in which it is conveyed into the bending station.

U.S. Pat. No. 5,286,271 teaches a method for the thermal bending of sheets of glass which are transferred into a shaping station containing a suction-type upper bending form that has a downward facing shaping surface. The sheet of glass is lifted up into contact with the shaping surface and held against the latter by suction. The mold and the sheet of glass are then moved into a transfer station and the suction is eliminated so that the bent sheet of glass can be set down onto a profiled transport surface.

In methods of the type that has just been described, it is near impossible to determine visually whether the glass is being positioned correctly under the bending form and problems of incorrect final shaping are often incorrectly interpreted. As an example of an incorrect interpretation, the positioning of the sheets as they enter the oven may be corrected in the wrong direction thereby amplifying the actual incorrect positioning of the glass under the tooling. On the other hand, incorrect shaping observed may be wrongfully attributed to incorrect positioning under the bending form. In that case, the operator modifying this positioning may have a tendency to increase the instability of the method. In addition, permanent monitoring throughout the production process is impossible because the operator is also busy with other tasks. Detection and rapid correction of drifts in the positioning under the bending form is therefore impossible in the prior art. The frequent drifts or incorrect settings, through lack of fine, reliable and constant monitoring, rapidly translate into increases in glass breakage and reject rates.

A device for detecting the position of a sheet of glass conveyed by a conveying means comprising a stop for coming into contact with the edge face of the sheet of glass has now been developed, said device delivering an electrical signal when the sheet of glass is in contact with said stop. It is the edge face of the sheet of glass that comes into physical contact with the stop as the glass is being conveyed. The use of a single stop establishes that a sheet has arrived at a precise point. The electrical signal delivered by the device may thus be used to trigger the next phase of the method that is to be applied to the sheet, such as, for example, a bending method that may involve the sheet of glass in the correct position being taken over by a bending tool. In general, contact between the sheet of glass and the stop corresponds to a stop position of the sheet in the course of its being conveyed, in particular on a bed of rollers. The means for conveying the sheets individually one after the other is generally a bed of rollers but may also be an air cushion, a belt, a full-track conveyor (two parallel caterpillar tracks supporting and driving the sheets), a belt conveyor or the like.

The sheets are considered to circulate under the action of the conveying means on a surface referred to as the “conveying surface”. This surface is generally planar. This surface may be made up of the uppermost points of a bed of conveying rollers. If these rollers are rectilinear, parallel and aligned in one and the same plane then the conveying surface is planar. The rollers may, however, be non-linear and therefore curved in a transverse direction, which means to say a direction perpendicular to the direction of conveying (which is itself referred to as the longitudinal direction) so as in particular to pre-bend the sheets in the transverse direction by sag bending under the effect of their self-weight on the rollers. The conveying surface on which the sheets circulate is then no longer planar but curved in the transverse direction. WO2014053776 teaches a curved rollers structure of this type, for use in conveying sheets of glass.

The sheets circulate on the conveying surface and come into contact with stops at a location referred to hereinafter as the “receiving surface”. This receiving surface is the surface on which each sheet is stopped and needs to be correctly positioned and oriented when viewed from above, so that it can undergo subsequent processing, in particular bending.

The use of a single stop informs as to the presence of a sheet in contact with the stop but does not inform as to the orientation of the sheet in the conveying surface at the moment that it comes into contact with the stop. Now, the sheet is generally polygonal and its correct orientation in the plane of conveying generally assumes a great importance. By way of example, it will be readily understood in fact that a rectangular sheet to be bent against a cylindrical bending form must not arrive under the bending form with some arbitrary orientation. The use of two stops according to the invention makes it possible to determine the orientation of the sheet of glass at the moment it comes into contact with the first stop, by deduction from the length of time elapsed between the two contacts. This information makes it possible to reestablish the correct orientation of the sheet on the loading of the sheets at the start of conveying, so that the method can continue correctly. Specifically, the stops are positioned optimally for the remainder of the processing of the sheets, in particular bending, so that a zero length of time between the contacts between a sheet and the stops corresponds to the best situation.

Moreover, because the sheet is driven by the conveying device until it comes into contact with the two stops, its orientation is also automatically corrected by the physical action of the stops on the sheet. Thus, the detection device comprises two stops each to come into contact with the edge face of the sheet of glass, said device delivering an electrical signal relating to each contact with each stop. Each stop generates an independent electrical signal as it comes into contact with the sheet, the electrical signals being coupled to an acquisition system making it possible to establish the length of time between contacts between the sheet of glass and each stop. Specifically, the two stops are positioned optimally for the sheets of glass. When the sheet touches one stop, the conveying means continues to push the sheet until it touches the second stop. The sheet is therefore turned as a result of these non-simultaneous two contacts and the orientation of the sheet is thus corrected in order to adopt the optimal position imposed by the two stops. The acquisition of the electrical signals delivered by the device makes it possible to detect which stop was touched by the sheet first and how much time was required by the sheet before touching the second stop. This data can then be used to correct the positioning of the following sheets on the conveying means so that these touch the two stops at the same time or, at the very least, with the shortest possible length of time between the two contacts. Indeed it is preferable for the sheets to arrive at the stops in a position that is as close as possible to the optimal position so that the conveying means has the least amount of action to perform on the sheet in order to cause it to touch the second stop. This makes it possible to speed up the method being applied to the sheets and, furthermore, generally makes it possible to reduce the risk of marking the underside of the sheet. Specifically, the action of the conveying means, in particular a bed of rollers, on the sheet when the sheet is already in abutment against one of the stops may make marks on its surface, especially if the sheet is at its thermal bending temperature. Because the discrepancy in the positioning of the sheet in relation to the desired optimal position is known, the orientation of the sheets when they are being placed on the conveying means can be corrected so that the length of time between contacts with the two stops is as short as possible. In addition, if the sheet arrives at the stops in the optimum orientation (simultaneous contact between the sheet and the two stops) or a near-optimal orientation, the next phase of the method that is to be applied to the sheet can occur immediately. The entire manufacturing process is therefore speeded up.

The two stops generally constitute a limit to the movement of the sheets in the direction of conveying referred to as the longitudinal direction, which means that each sheet has to pause on contact with the two stops. It is the stops that stop the sheet. The combined action of the two stops also corrects the orientation of the sheet and places it in the optimum position for the next phase of the method.

The invention relates to a device and a method as featured in the claims.

The invention relates to a conveying device for conveying and a detection device for detecting the orientation of sheets of glass advancing one behind the other comprising a conveying means for conveying the sheets of glass in a longitudinal direction and a detection device for detecting the orientation of a sheet of glass comprising two stops each to come into contact with the edge face of the sheet of glass, said detection device delivering an electrical signal relating to each contact with each stop, the electrical signals relating to each stop being coupled to an acquisition system making it possible to establish the length of time between contacts between the sheet of glass and each stop. In particular, the conveying means is a bed of rollers, conveying the sheets of glass in a longitudinal direction.

In particular, the stops may constitute a limit to the longitudinal movement of the sheet of glass by stopping it. The detection device according to the invention takes on the task of determining the position and orientation of a single sheet of glass at a time. The sheets advancing individually one after another are intended to undergo the same process one after another, in particular a bending process, and the detection device informs as to the presence and orientation of each sheet one after the other, so that this subsequent processing operation can be performed.

There are a number of items of information that can be exploited using the electrical signals delivered by the two stops according to the invention:
the order of successive contacts with the various stops;
the time of contact with each stop;
the time and calculation of the offset between several stops;
the drift in the time of contact or order of contact over time.

For preference, as soon as the two stops are in contact with a sheet of glass, the conveying means in contact with the sheets, in particular a bed of rollers, stops so as to mark the glass as little as possible. The stopping of the rollers may be slaved to detection of contact with the two stops. However, the mechanical inertia of the conveying device is generally too high for such slaving to be effective and sufficiently rapid. Indeed it is not generally permissible to wait until contact with the stops has been detected before triggering the stopping of the conveying device, because such an approach could lead to the rollers marking the underside of the sheets. It has been found that it is preferable to plan to operate the conveying means independently of the signal delivered by the stops. The action of the conveying means is then advantageously slaved to detection of the arrival of a sheet of glass by a “sheet-arrival detector” distinct from the stop device according to the invention and positioned upstream of the stops, in particular an optical telemeter. The sheet-arrival detector triggers the slowing of the conveying means before the sheet comes into contact with one of the stops. In instances in which the sheet needs to be positioned in vertical alignment with the bending tools, the “sheet-arrival detector” is preferably positioned upstream of the bending tools. The term “upstream” refers to a position that is earlier on in the process followed by a sheet of glass, in particular in its path in the longitudinal direction toward the stops. The method then follows the following process when a sheet arrives:
a) detection of the arrival of a sheet by the sheet-arrival detector, said detection triggering
b) the slowing of the conveying means before the “sheet for pressing” comes into contact with one of the stops, then the stopping of the conveying means so as to be certain that contact between the sheet and the stops has occurred, then
c) after the conveying means has stopped and the sheet is therefore in contact with the stops, retraction of the stops, then
d) continued processing of the sheet which has stopped in the optimum position on the stationary conveying means.

The “sheet for pressing” is the sheet in an optimum position to be pressed against the upper bending form by a pressing means.

There is no need to slave one of the these steps a) to d) to the electrical signals delivered by the device according to the invention. However, the retraction of a stop could be made conditional on detection of the electrical signal relating to it, provided that it is possible to be certain that the stop will not be retracted until after the conveying means has stopped. The step d) could also be made conditional on detection of the electrical signal relating to the stops. Step b) needs to be optimized through experimentation. The device needs to be set up so that the conveying means definitely stops after the sheet has come into contact with the stop or stops, a situation which is refined through routine testing. The stops are then used to stop the sheet in the correct position on the longitudinal axis of conveying and to give it the optimal orientation so that it can be processed later in step d). The device according to the invention is also used to analyze any drift in the orientation of the sheets when viewed from above in the conveying surface, which is generally planar and horizontal.

After the conveying means has stopped and therefore also after the sheet in contact with the stops has stopped, these stops are preferably retracted so that the subsequent movement intended for the sheet is not accompanied by the sheet rubbing against at least one stop. In this case, any stop is retracted after the start of contact with the edge face of the sheet of glass and before the bending by pressing so as to avoid the stop rubbing against the sheet when the sheet is lifted up. For example, a stop may be removed in a movement comprising a component in the longitudinal direction and, if appropriate, in combination with a vertical component, in particular upward. According to this embodiment, a stop is removed at an angle upward and away from the sheet, namely in a movement that combines an upward vertical component and a horizontal component in the longitudinal direction. The movement of a stop may be brought about by means of a pneumatic actuating cylinder.

After the stops have been retracted and the sheet that has come into contact with them has been processed (in particular bent), with said sheet continuing on its way through the next phase of the method, the stops return to their initial position so as to come into contact with a following sheet.

The stops may be connected in particular to the upper bending form or to a pressing frame or to a structural element of the conveying or bending device.

After the conveying means has stopped and therefore also after the sheet has stopped in the optimum position, any stop of the device having been retracted as appropriate, the sheet is ready to undergo the intended process, which may be a thermal bending operation (which means to say a “hot” bending operation at a plastic deformation temperature as opposed to a cold bending operation) generally carried out between 550 and 750° C. A thermal bending is performed irreversibly on a sheet of glass because it is performed at a plastic deformation temperature and followed by a cooling to below its plastic deformation temperature. The thermal bending may be performed by pressing the sheet for pressing against the upper bending form using a pressing means. This pressing means applies pressure to the underside of the sheet of glass and at least to the periphery thereof. The pressing means acts under pneumatic force or mechanical force in order to press the sheet firmly against the upper bending form and bend it.

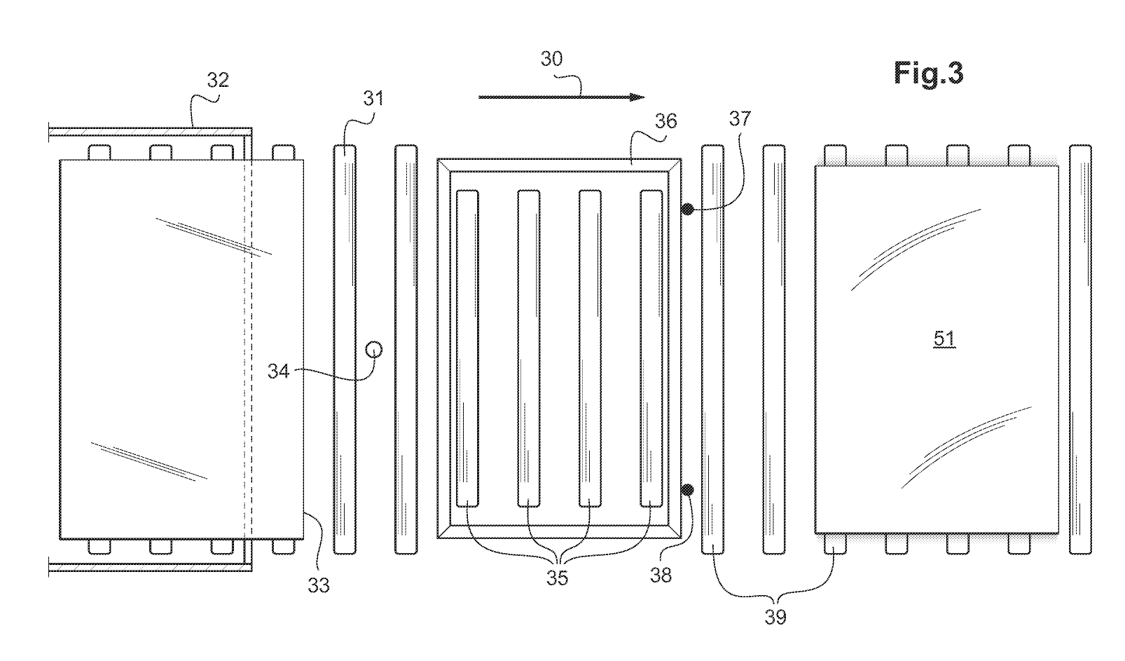

The pressing means for pressing the sheet against the upper form may be pneumatic in nature, for example a blowing from underneath and blowing, in particular, between the conveying rollers onto the underside of the sheet, or such as suction from the top of the sheet. Suction of the top face of the sheet may be applied through orifices formed in the bending face of the upper bending form. Suction may also be applied by way of a skirt surrounding the upper bending form. FIG. 3 of WO2011/144865 shows an upper bending form provided both with orifices in its bending face for sucking the upper face of the sheet and with a skirt 39 surrounding the upper bending form in order to create an upward flow of air that sweeps over the edge of the sheet.

The means of pressing the sheet against the upper form may be mechanical in nature and in that case comprises a pressing frame having curvatures that correspond to those desired for the final shape of the sheet of glass and therefore also curvatures that complement the upper bending form. In that case, the sheet for pressing is pressed between two bending tools—an upper bending form and a pressing frame.

Thus, the invention also relates to a device for bending sheets of glass comprising the conveying device according to the invention, comprising an upper bending form, a pressing means for pressing a sheet that can press its periphery against the upper bending form, the longitudinal position of the sheet at the moment it is taken over by the pressing means being a stop position imposed by the stops. In particular, the pressing means may comprise a pressing frame having a shape that complements that of the upper bending form, said pressing frame being able to support the periphery of the sheet for pressing, the upper bending form and the pressing frame being able to move toward one another in order to press between them the sheet for pressing.

The upper bending form may be of the skeleton frame type or may be a full-surface die. A full-surface bending die comes into contact with the glass not only at its periphery but also over the entire surface of the glass and in particular in the central region thereof. This full-surface die may have orifices on its surface that contact the glass, through which orifices suction or blowing may be applied. Suction is applied in particular when the sheet of glass that has just been bent needs to be held by the upper bending form while the pressing frame is lowered back down and is no longer in contact with the sheet. Blowing may potentially be applied through the same orifices when there is a desire to accelerate the separation of the sheet from the upper form, in particular when it is to be set down on a cooling frame. The surface of the upper bending form that comes into contact with the glass is generally convex. The upper bending form may also be provided with a skirt so that suction can be applied around it. After the sheet has been pressed, it is kept in contact with the upper bending form by suction applied through its orifices as the pressing frame is lowered back down, then a cooling frame is placed under the sheet still in contact with the upper bending form, then the suction is halted and the sheet is collected by the cooling frame, then the cooling frame carries the bent sheet into a cooling zone, then the sheet is cooled.

It is also possible for the upper bending form not to comprise orifices on its bending surface. In that case, the sheet is lowered back down after pressing, on the pressing frame. This pressing frame descends below the sheet receiving surface, in particular below the level of the “positioning rollers” placed under the upper bending form. These “positioning rollers” are the last rollers of the bed of rollers to receive the sheets of glass prior to bending and are the ones on which each sheet for pressing needs to be correctly positioned. For that reason they are referred to as “positioning rollers”. The bent sheet is thus placed back on the bed of rollers, which can then carry the bent sheet to a cooling zone. In that case, the stops do not return to their position to stop a following sheet until the bent sheet has been removed from the receiving surface.

In particular, the positioning rollers may have a curved shape close or even identical to the shape of the bent sheets, in a transverse direction (direction orthogonal to the longitudinal direction corresponding to the overall direction of travel of the sheets). In that case, when the sheets prior to bending arrive under the upper bending form, it is possible that they may not completely hug the positioning rollers at this stage.

The pressing frame comprises a contact rail to support the sheet of glass. This rail has a shape that complements that of the full-surface bending die, this shape corresponding to the shape finally desired for the sheet. If the upper bending form is convex, the contact rail of the pressing frame has concave curvatures. When the sheet for pressing arrives between the bending tools, the contact rail of the pressing frame is underneath the surface whereat the rollers receive the sheet of glass.

A bed of rollers carries the sheets of glass one after the other into an optimum position under the upper bending form. Positioning rollers of said bed, generally 2 or 3 or 4 rollers or even more, are positioned under the upper bending form. These positioning rollers do not impede the upward movement of the pressing frame. In general, these positioning rollers under the upper bending form are not as long as the other rollers of the bed and, when viewed from above, lie inside the interior contour of the pressing frame. In that way, the pressing frame can pass above or below the receiving surface for the sheet of glass which surface is formed by these positioning rollers. The positioning rollers can also be as long as the other rollers without impeding the upward movement of the pressing frame if the latter is segmented. They may therefore protrude beyond the bending frame when viewed from above. In that case, the bending frame has a contact rail that is discontinuous facing the underside of the sheet of glass, the contact rail of the bending frame then being made up in part of segments that pass between the rollers during the vertical movement of the bending frame. These segments may be cutouts formed in the sides of the bending frame such as on the frame referenced 21 in FIG. 3 of WO02/06170. Thus, the bending frame may have a contact rail that is continuous or discontinuous facing the underside of the glass. The bending frame may even support just two sides of the sheet of glass, in which case it may be made up of two segments. In general, the segments support the longest sides of the sheet of glass. The bending frame preferably comes into contact with all the sides of the sheet of glass, all of them offering contact, possibly discontinuous contact.

The bed of rollers is a driving bed because it causes the sheets of glass to advance into their optimal position under the upper bending form. The positioning rollers are also drive rollers. The positioning rollers slow down and stop after the sheet of glass comes via its edge face into contact with the intended stops. The sheet of glass known as the sheet for pressing achieves its optimal position under the upper bending form by coming into abutment via its edge face with at least two position stops.

After the pressing that gives the sheet its final shape, the sheet needs to be cooled so that it retains its bent shape. In general, after pressing, the upper bending form keeps the sheet against it using suction applied through orifices on its surface of contact with the sheet, allowing the pressing frame to descend again without taking the sheet with it. A cooling frame is then brought in under the upper bending form, generally through a movement involving at least a horizontal component. The suction applied by the upper bending form is then cut off and the bent sheet of glass is then collected by the cooling frame. A small amount of blowing may even be performed by the upper bending form in order to help with separating the sheet of glass from the upper bending form. The cooling frame advantageously has the desired final shape for the sheet. The cooling frame therefore moves to take the bent sheet of glass to the cooling zone. If appropriate, a thermal tempering or hardening may be applied to the sheet through the blowing of cooling air.

All of the tools that come into contact with the glass (pressing frame, upper bending form, cooling frame) are generally covered with a refractory textile that softens their contact with the glass and limits the risk of marking. These bending tools may be located in an oven (which means to say inside a heated space) that keeps the glass at its deformation temperature, generally between 550 and 1000° C. In the case of the shaping of a sheet of soda-lime glass, the temperature is generally comprised in the range from 550 to 700° C. In the case of the shaping of a sheet of glass that is a precursor to a vitreous ceramic, the temperature is generally comprised in the range from 700 to 1000° C. However, in general, these bending tools are not situated inside an oven, but just after an oven that has heated the sheets to their thermal bending temperature. In that case, the bed of conveying rollers passes through an oven to raise the sheets to their deformation temperature, leaves the oven and carries the sheets of glass in under the upper bending form situated outside the oven, just after the exit from the oven.

The invention also relates to a method for conveying sheets of glass using the device according to the invention comprising the conveying of the sheets of glass in a longitudinal direction one behind the other by a conveying means followed by contact between the edge face of a sheet of glass and the stops followed by the establishing by the acquisition system of the length of time between contacts between the sheet of glass and each stop. In particular, after said length of time has been established, the orientation of the following sheets of glass, these being upstream of the sheet that has already come into contact with the stops, is modified in order to shorten the length of time between contacts between said following sheets of glass and each stop compared with the length of time between contacts between the sheet that has already come into contact with the stops and each stop.

The invention also relates to a method for bending sheets of glass advancing one after the other using the bending device according to the invention, comprising the taking-over by the conveying means, in particular a bed of rollers, of the sheets of glass one after the other, followed by, for each sheet of glass one after the other, contact between the edge face of the sheet of glass for pressing and the stops, followed by the bending of the sheet of glass for pressing by pressing against the upper bending form, in particular by a bending frame. In order for the sheets of glass to be taken over by the conveying means, in particular a bed of rollers, these sheets are generally laid down manually or by a robot at the start of the conveying means.

The device for detecting the position of the sheet of glass for pressing comprises two stops, the electrical signals relating to each stop and delivered by the detection device being coupled to an acquisition system making it possible to establish the length of time between contacts between the sheet of glass and each stop. After the length of time between contacts of a sheet of glass that has come into contact with each stop has been established, the orientation of sheets of glass upstream of said sheet can be modified in order to shorten said length of time. In particular, the orientation of the sheets of glass upon loading onto the conveying means, in particular a bed of rollers, can be modified if necessary in order to shorten said length of time. In particular, the conveying means causes the sheets of glass to pass through an oven in order to raise them to their plastic deformation temperature so that they can be bent, the orientation of sheets of glass upstream of the sheet that has come into contact with each stop being modified to take account of the information delivered by the acquisition system preferably upstream of the oven.

The invention provides a response to the tightening of tolerances by automotive manufacturers and the increasing demand to reduce production costs and waste. The invention constitutes a system that makes the positioning of the glass under a pressing form more reliable. It makes it possible to reduce scrap and is particularly well suited to high production rates. The device according to the invention may be installed on standard shaping toolings in a free environment and makes it possible to monitor and correct precisely the position of the glass with respect to the shaping tooling, just before the pressing cycle begins. The detection is precise, reliable and available in real-time and makes it possible to detect drifts in the orientation of the sheets and thus allows corrective action to be taken in the method as quickly as possible. In the context of a bending method, the invention makes it possible to achieve better geometric conformity of the glazing and increased stability throughout production. The invention provides an aid to the decision-making process making it possible, through the rapid correction of the position of the glass under the bending tool, to significantly reduce the number of glazings that are broken or rejected on account of defective geometry. The detection device is coupled to an acquisition system that acquires measurements in real time, thereby allowing the plant operator to easily detect drifts or analyze the run after the fact. The device is particularly well suited to identifying slow drifts in the positioning of the glass under a press tool and allows rapid reaction on the positioning of the glass entering the oven. Specifically, the device makes it possible to identify drifts in positioning before these result in rejected curvatures. In addition, equipped with a suitable interface, it may indicate the direction in which the operator needs to correct the position of the glass entering the oven.

The conveying and detection device according to the invention may comprise a correction system for automatically correcting the orientations of the sheets (referred to as the following sheets of glass) upstream of a sheet of glass in contact with the stops, as a function of the length of time, measured by the acquisition system, between the contacts between said sheet (the one that has already come into contact with the stops) and each stop. The automatic correction produces a shortening of the length of time between contacts between the following sheets of glass and each stop compared with the length of time between contacts with each stop of the sheet of glass already in contact with the stops. This correction of orientation performed for sheets upstream of the one that is in abutment may be performed by elements of the stop or bar type coming into contact with the glass, in particular the edge face thereof, in order to return it to the correct orientation. The correction of the orientation of the sheets may also be performed as soon as the sheets are taken over by the conveying means, for example as soon as the sheets are laid (manually or by a robot) on a bed of rollers. In this case, it is the laying of the sheets on the conveying means that is modified in order to give the sheets the correct orientation directly without there being any need to use elements coming into contact with the sheets of glass after they have been taken over by the conveying means. In that way, the correction of the drift in orientation occurs for a set of sheets until a new drift is detected. This system is particularly advantageous over a system that determines the orientation of each sheet in order to correct its orientation downstream of detection, because in that case action on each sheet is required. In addition, detection of the orientation of the sheets according to the invention is performed as close as possible to the point at which this orientation needs to be optimal. According to the invention, a control device may thus be connected to the acquisition system and automatically control the correction of the orientation of the sheets by acting on the elements that come into contact with the sheets or on the robot that lays the sheets on the conveying means, on the basis of the information provided by the acquisition system regarding the length of time between contacts between a sheet and the stops. Thus, the automatic correction of the orientation of the sheets can be performed when the sheets are first being taken over by the conveying means.

When the conveying device according to the invention comprises an oven to heat the sheets to their plastic deformation temperature, in particular so that they can be bent, the (manual or automatic) correction of the orientation of the sheets by elements that come into contact with the sheets is advantageously performed before they enter the oven. This is because the glass is then insensitive to marking and furthermore use may be made of a mechanical system that operates at ambient temperature.

Contact between a stop and the edge face of the conveyed sheet gives rise to a movement of the stop, said movement being converted into an electrical signal. The electrical signal delivered by the device as a result of the contact between the stop and the edge face of a sheet of glass may come from detection within the device of the movement of the stop or of a component connected directly or indirectly to it, it being possible for said detection to be of the “contactless detection” type, or may alternatively come from actual electrical contact. In particular, a micromovement of a component of the device may be transmitted pneumatically. In particular, a stop that comes directly into contact with the edge face of the sheet of glass may move slightly under the effect of the pressure from the sheet of glass and give rise to detection. This movement at the level of the sheet of glass (which means to say in the horizontal of the sheet) in the longitudinal direction of overall travel of the sheets may for example be comprised in the range from 0.2 to 1.5 mm.

In general, the conveying speed is comprised between 800 and 2000 mm/s. This is the maximum speed of the sheets in the longitudinal direction, it being understood that on nearing the stops, the speed of a sheet is greatly reduced as a result of the slowing of the rollers. The contact of a sheet of glass with two stops is considered to be simultaneous if the length of time between contacts between the sheet and the two stops is less than 30 ms, and preferably less than 20 ms. This length of time corresponds to a distance that the side of the sheet that is second to come into contact with a stop has to cover of less than 0.2 mm and preferably less than 0.1 mm in the longitudinal direction. If the contacts with the two stops are considered to be simultaneous, it is reckoned that there is no need to correct the orientation of the sheets at the start of conveying.

The device according to the invention is designed to operate in an environment that is harsh (splashes of hot glass, repetitive movements, tempering air) and hot because of the proximity of an oven and strong draughts of hot air and contact with the edge face of the hot sheets. A stop comes into contact with the glass via a contact piece made of a suitable material which may be a high thermal resistance polymer, possibly reinforced with a mineral substance. This contact piece is made to be removable so that it can be replaced if worn. This system is therefore well suited to evolutions in contact materials. The detection could also work without actual contact with the glass by virtue of the use of an optical system in particular of the laser type. Detection of the position and orientation of the glass by the stops can be used to slave the adjusting of the orientation of the sheets of glass entering the oven directly as a function of the detected positions of the glass.

The present invention relates to any type of glass, clear or tinted, coated with at least one layer, enameled or not enameled. The sheet processed according to the invention may be used for any application in the automotive or agricultural field (car, truck, bus, etc.) to act as a windshield, rear screen, side window, quarterlight, roof, bayflush or other window. The sheet processed according to the invention may also be used in any field outside of the automotive field such as building, solar, specialist applications, aeronautics, vitreous ceramic hobs, etc.). The sheet processed according to the invention may be of any thickness, generally comprised in the range from 1 to 100 mm, and may have any dimension of the main faces. Following processing according to the invention, the sheet may be tempered. After processing according to the invention, the sheet may be incorporated into laminated glazing. After processing according to the invention, the sheet may be ceramicized by a subsequent heat treatment if it is of the type that forms a vitreous ceramic precursor.

The sheets may in particular integrate laminated glazing. The sheets may, during the cooling that follows their bending, undergo an annealing treatment.

FIG. 1 depicts a stop 1 used in the context of the invention and viewed from the side. A sheet of glass 2 is conveyed by a bed of rollers of which just one roller 3 has been depicted. The uppermost points 14 of the rollers form the conveying surface 15. The sheet of glass is approaching the stop that constitutes the limit on its movement in the longitudinal direction 5. This stop comprises a cylindrical ring 4 made of a material suited to contact with the hot glass. Contact between the stop and the edge face of the glass causes the ring to move slightly in the longitudinal direction. The stop therefore pivots about the pivot 9 and causes the metallic component 6 and the contactless sensor 7 to move closer together. This movement is detected by the contactless sensor 7 and results in the delivery of a signal via the cable 8. The component 10 is a spring pushing the components 6 and 7 away from one another when no sheet is pressing against the stop. The sheet 2 will be in an optimum position when it is in contact with the stop 1. It lies between two bending tools, the pressing frame 11 and the upper bending form 12. When the sheet 2 is in the optimum position and the rollers 3 have stopped, the stop 1 is removed in the direction 13, said direction comprising a vertical component and a horizontal component such that the material 4 does not rub against the glass during the removal. After the stop has been removed, the pressing frame 11 moves up to pick up the sheet 2 and press it against the convex upper form 12.

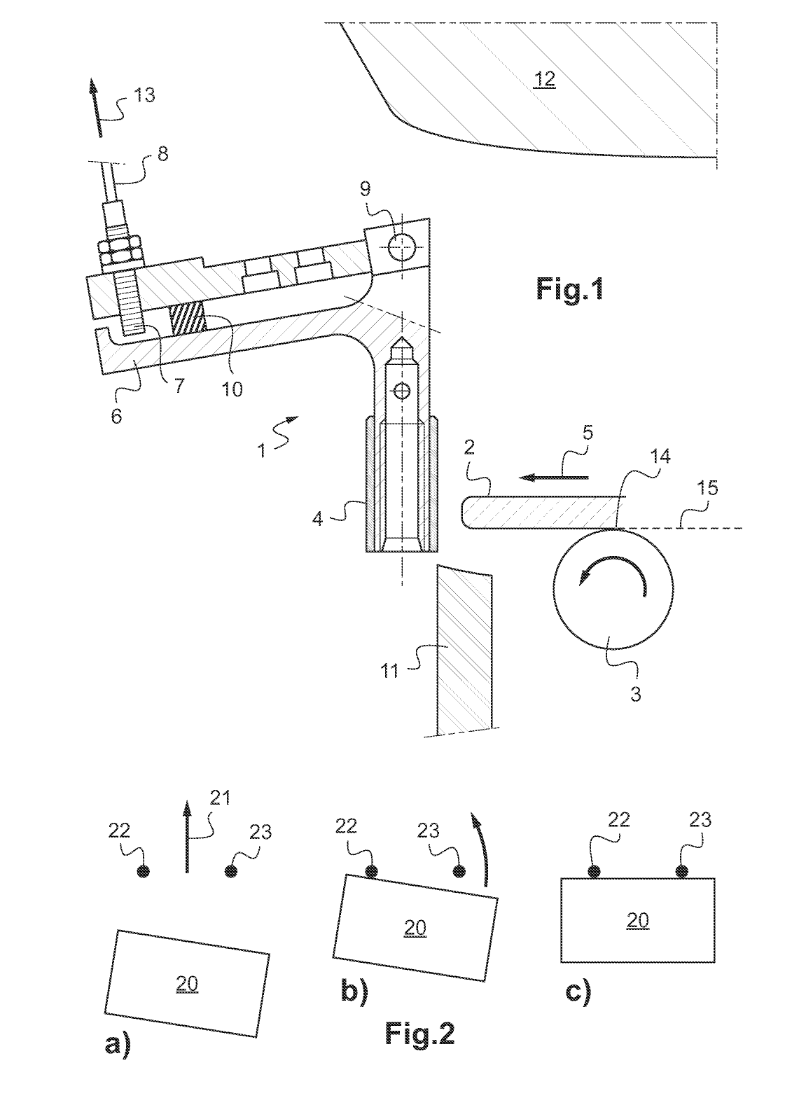

FIG. 2 shows, viewed from above, how two stops 22 and 23 act with respect to a sheet of glass 20 conveyed in a longitudinal direction 21 but incorrectly positioned on the bed of rollers (which is not depicted) before they enter the oven. The plane of the figure is parallel to the conveying surface for the sheets. The incorrect orientation in the plane of conveying has been exaggerated for ease of understanding. At a), the incorrectly oriented sheet has not yet arrived between the bending tools (not depicted). At b) the sheet has touched the stop 22 but has not yet touched the stop 23. Only the stop 22 has delivered an electrical signal at this stage. The sheet therefore pivots about the stop 22 under the driving action of the positioning rollers underneath it. Only the stop 22 has delivered an electrical signal at this stage. At c) the sheet is also touching the stop 23 and thus in its optimal position between the bending tools. After the positioning rollers stop, the bending cycle can begin.

FIG. 3 shows a conveying and bending device according to the invention, viewed from above, the upper bending form having not been depicted. The sheets of glass are conveyed by the bed of rollers 31 in a longitudinal direction 30. The planar sheets are first of all heated up to their bending temperature in an oven 32 situated upstream of the actual bending cell proper. The sheet 33 is depicted as being in the process of leaving the oven to enter between the bending tools. A detection cell 34, in particular an optical or some other form of cell, positioned under the conveying surface for the conveying of the sheets detects the passage of the sheets between two rollers before arriving between the bending tools. The signal given by this detection cell is used to slow and stop the four rollers 35 placed between the bending tools and referred to as “positioning rollers”. These positioning rollers are circumscribed, when viewed from above, by the pressing frame 36 which is able to move vertically and under the surface via which the positioning rollers 35 receive the sheets in order to allow the next sheet for pressing to pass. The driving action of the positioning rollers is regulated so that the sheet for pressing will definitely touch the two stops according to the invention 37 and 38. When the sheet is in contact with these two stops, the positioning rollers 35 stop then the stops 37 and 38 are retracted, then the pressing frame 36 moves up to pick up the sheet for pressing and press it against the upper bending form (not depicted). Once bending has been performed, the pressing frame descends with the sheet again. The pressing frame descends below the sheet receiving surface formed by the top of the rollers, these then receiving the bent sheet. The rollers then drive the bent sheet 51 toward a cooling and unloading zone. If appropriate, the rollers 39 may have a transverse curvature corresponding to that of the bent sheets. After the sheet 51 has been discharged in the longitudinal direction, the stops 37 and 38 return to their position to perform, with respect to the sheet 33, the same role as they performed in respect of the sheet 51.

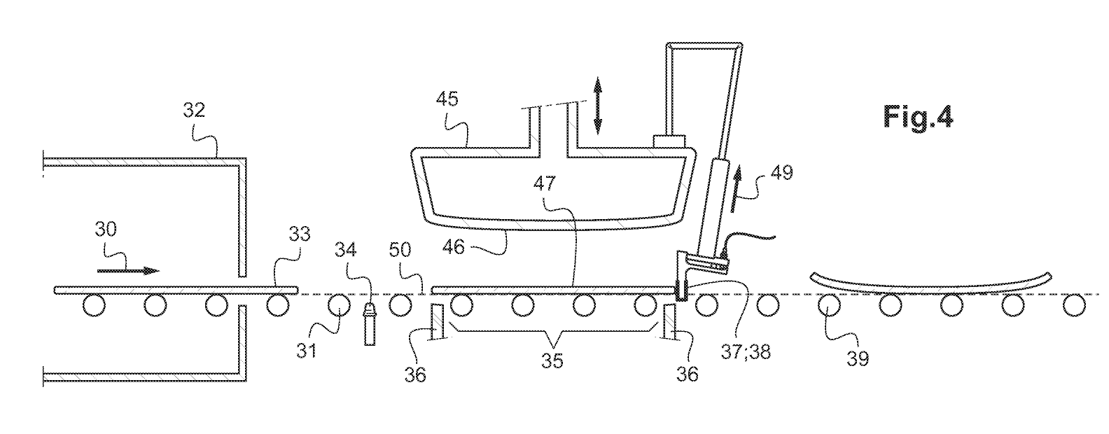

FIG. 4 depicts the same device and the same method as the one in FIG. 3 but viewed from the side. The same reference signs have been kept to denote the same elements. The conveying surface is formed by the top of the rollers and is indicated by a horizontal dotted line 50. The stops 37 and 38 are depicted in position for stopping the conveying of the sheet for pressing 47 in the direction of conveying 30. The pressing frame 36 is depicted still below the level of the conveying 50 and receiving surface (underneath the upper bending form 45 which can move down or up) for conveying and receiving the sheet for pressing via the rollers. When the sheet for pressing 47 is in the correct position, the stops 37 and 38 are retracted upward at an angle in a movement in the direction 49 that comprises a vertical component and a horizontal component in the longitudinal direction. Once the stops have been retracted, the pressing frame 36 moves upward to pick up the sheet for pressing and press it against the upper bending form which is lowered to meet the sheet of glass. After bending, the sheet is lowered back down by the frame 36 onto the bed of rollers, which is set in motion, and the bent sheet is thus removed to the right in the figure.

1. A conveying device for conveying sheets of glass advancing one behind the other, the conveying device comprising a conveyor configured to convey the sheets of glass in a longitudinal direction and a detection device for detecting an orientation of a sheet of glass, the detection device comprising two stops each to come into contact with an edge face of the sheet of glass, said detection device delivering an electrical signal relating to each contact with each stop, said electrical signals being coupled to an acquisition system making it possible to establish a length of time between contacts between the sheet of glass and each stop.

2. The device as claimed in claim 1, wherein contact between a stop and the edge face of the conveyed sheet of glass gives rise to a movement of the stop, said movement being converted into an electrical signal.

3. The device as claimed in claim 2, wherein the movement of the stop at a level of the sheet of glass is comprised in the range from 0.2 to 1.5 mm.

4. The device as claimed in claim 1, wherein the stops are retractable after the stops have come into contact with the edge face of the sheet of glass.

5. The device as claimed in claim 1, wherein the stops constitute a limit to a longitudinal movement of the sheet of glass.

6. The device as claimed in claim 1, further comprising a sheet-arrival detector that triggers a slowing of the conveyor before a sheet of glass comes into contact with one of the stops.

7. The device as claimed in claim 1, wherein the conveyor is a bed of rollers.

8. The device as claimed in claim 1, further comprising a correction system for automatically correcting the orientation of following sheets of glass, upstream of a sheet of glass that has come into contact with the stops, as a function of the length of time, measured by the acquisition system, between contacts between the sheet of glass that has come into contact with the stops, and each of the stops.

9. The device as claimed in claim 8, wherein the automatic correction produces a shortening of the length of time between contacts of the following sheets of glass and each stop compared with the length of time between contacts between the sheet of glass that has come into contact with the stops and each stop.

10. The device as claimed in claim 1, further comprising an oven for heating the sheets of glass to their plastic deformation temperature, the automatic correction of the orientation of the sheets being able to be performed by elements that come into contact with the sheets of glass before the sheets of glass enter the oven.

11. The device as claimed in claim 1, wherein the automatic correction of the orientation of the sheets of glass can be performed when the sheets of glass are first taken over by the conveyor.

12. A bending device for bending sheets of glass comprising the device as claimed in claim 1, the bending device comprising an upper bending form, a pressing device configured to press a sheet of glass at its periphery against the upper bending form, the longitudinal position of the sheet of glass at the moment the sheet of glass is taken over by the pressing device being a stop position imposed by the stops.

13. The bending device as claimed in claim 12, wherein the pressing device comprises a pressing frame.

14. A method for conveying sheets of glass using the device as claimed in claim 1, the method comprising conveying the sheets of glass in a longitudinal direction one behind the other by the conveyor followed by establishing a contact between the edge face of a sheet of glass and the stops followed by establishing by the acquisition system the length of time between contacts between the sheet of glass and each stop.

15. The method as claimed in claim 14, wherein after said length of time has been established, the orientation of the following sheets of glass, upstream of the sheet of glass that has come into contact with the stops, is modified in order to shorten the length of time between contacts between the following sheets of glass and each stop compared with the length of time between contacts between the sheet of glass that has come into contact with the stops and each stop.

16. The method as claimed in claim 15, wherein the modification of the orientation of the following sheets of glass is performed as the sheets of glass are loaded onto the conveyor.

17. The method as claimed in claim 14, wherein a sheet-arrival detector triggers a slowing of the conveyor before a sheet of glass comes into contact with one of the stops.

18. The method as claimed in claim 14, wherein the stops constitute a limit to the longitudinal movement of the sheet of glass.

19. A method of bending sheets of glass comprising conveying of sheets of glass according to the method as claimed in claim 14, taking-over by the conveyor the sheets of glass one after the other, followed by, for each sheet of glass one after the other, establishing a contact between the edge face and the stops, followed by bending the sheets of glass by pressing against an upper bending form.

20. The method as claimed in claim 19, further comprising retracting the stops after the stops have begun to come into contact with the edge face of the sheet of glass for pressing and before the sheet of glass is bent by pressing.

21. The method as claimed in claim 20, wherein after a sheet of glass has been bent, the stops return to their position in order to come into contact with the following sheet.

22. The method as claimed in claim 19, wherein the conveyor causes the sheets of glass to pass through an oven in order to raise the sheets of glass to their plastic deformation temperature prior to bending, the orientation of the sheets of glass upstream of the sheet of glass that has come into contact with each stop being modified upstream of the oven.

23. The method as claimed in claim 22, wherein the modification of the orientation of the sheets of glass leads to a shortening of the length of time between contacts between the sheets of glass and each stop.

24. The method as claimed in claim 19, wherein the bending by pressing is performed by a pressing device comprising a pressing frame.

25. The device as claimed in claim 6, wherein the sheet-arrival detector is an optical telemeter.

26. The method as claimed in claim 17, wherein the sheet-arrival detector is an optical telemeter.
